(19) United States
(12) Patent Application Publication
(10) Pub. No.: US 2026/0169462 A1
(43) Pub. Date: Jun. 18, 2026

(54) DEVICES AND METHODS FOR DYNAMICALLY ADAPTING THERMAL CONSTRAINTS ON THE OPERATION OF COMPUTING DEVICES

(71) Applicant: Advanced Micro Devices, Inc., Santa Clara, CA (US)

(72) Inventors: Yuan David Ma, Austin, TX (US); Yoshifumi Nishi, Austin, TX (US); Michael J. Austin, Austin, TX (US)

(73) Assignee: Advanced Micro Devices, Inc., Santa Clara, CA (US)

(21) Appl. No.: 18/984,208

(22) Filed: Dec. 17, 2024

(51) Int. Cl. G05B 19/4155

(52) U.S. Cl. CPC G05B 19/4155; G05B 2219/49216

(57) ABSTRACT

A device for managing temperature thresholds in computing devices can include (i) a processor in an environment, (ii) at least one temperature sensor configured to monitor a temperature of the environment, (iii) a first controller configured to perform an action to reduce the temperature of the environment based on the monitored temperature of the environment reaching a first temperature threshold, and (iv) a second controller configured to dynamically adjust the first temperature threshold from a first value to a second value for a limited-duration time period based on the monitored temperature of the environment approaching the first value of the first temperature threshold and to maintain the second value of the first temperature threshold based on the monitored temperature remaining below a second temperature threshold for the limited-duration time period.

### BACKGROUND

Computing devices or their components are generally capable of and/or rated for safe operation within specified thermal constraints (e.g., temperature limits). Such limits can exist to protect components from damage caused by overheating and/or to protect users from being burned. There are various ways of keeping the temperatures of computing devices below these limits, such as operating fans to cool the systems and/or limiting the power provided to components that are beginning to overheat.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is a block diagram of an example computer system with a subsystem for dynamically adapting thermal constraints in the computer system.

FIG. 2 is a block diagram of an example system for dynamically adapting thermal constraints in computing devices.

FIG. 3 is a flow diagram of an example method for dynamically adapting thermal constraints in computing devices.

FIG. 4 is a graph of exemplary temperature thresholds.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

Some temperature control systems monitor the temperatures of computing devices via various types of thermal sensors, which can be positioned at various locations within the computing device. When the thermal sensors detect temperatures that meet or exceed static threshold temperatures, cooling measures such as fans and/or throttling (e.g., power throttling) can be activated. When activated, cooling fans can be loud, and device users can perceive their activation as an indicator of poor thermal design or poor performance of the temperature control system. Power throttling (e.g., reducing the supply voltage, reducing the clock frequency, stretching clock cycles, etc.) tends to reduce the device's temperature quietly, but at the cost of significantly degrading the device's computational performance.

The present disclosure describes systems and methods for maintaining safe operating temperatures of computing devices while balancing fan noise and performance by dynamically adjusting thermal constraints (e.g., temperature thresholds). In some examples, the systems described herein can measure thermal junction temperature (Tj) in a computing device (e.g., an accelerated processing unit (APU)) and can temporarily allow the measured Tj to exceed a steady-state Tj threshold (e.g. a Tj threshold associated with a sustained power limit) without throttling the power delivered to the device (even if the power delivered to the device temporarily exceeds the sustained power limit) and without increasing fan speed (despite Tj temporarily exceeding the steady-state Tj threshold). By basing the activation of cooling measures (e.g., power throttling, fan activation, etc.) on a dynamic Tj threshold rather than a steady-state Tj threshold associated with a sustained power limit, the systems described herein can improve device performance and reduce fan noise without exceeding the safe operating temperatures of computing devices.

Temperature control issues can be particularly problematic in accelerated processing units (APUs). Some APUs include a heterogeneous set of processing devices (e.g., different central processing unit (CPU) types (e.g., down-configured CPUs), different graphical processing unit (GPU) types (e.g., down-configured GPUs), etc.), which can have a wide range of package thermal resistances. Thus, the temperatures of these processing devices can vary widely even while the APU processes the same workload. Temperature-based power throttling can be common in such APUs. In some cases, power throttling can happen quickly, not just during sustained heavy-workload scenarios but also during routine or light workload scenarios characterized by short and/or bursty periods of heavy usage. For example, a background process that periodically runs for 5-10 seconds can trigger throttling. In many cases, end-users can perceive instances of power throttling as indicators of poor thermal design or poor system performance, even when the temperature control system operates as intended.

Because APUs can have mixed CPU and GPU power rails to simplify the voltage regulator design, it is often difficult for the APU's cooling system to safely support the same maximum power load (e.g., 100 W) across different workloads that have different resource utilization profiles. As used herein, a workload's “resource utilization profile” refers to the set of resources (e.g., CPUs, GPUs, etc.) used by the APU and the power levels at which the APU operates those resources to process the workload. For example, in an APU with a nominal 100 W thermal solution (e.g., a cooling system capable of safely dissipating the heat produced when an APU operates in a particular resource utilization profile and draws up to 100 W of power), the thermal solution can be configured such that it safely supports 100 W power loads only for GPU-centric workloads in which all of the APU's GPUs (e.g., 20 GPUs)are drawing nearly equal amounts of power and the APU's CPUs are drawing little or no power. Continuing the example, the thermal solution can be configured such that it safely supports a maximum 50 W power load for CPU-centric workloads in which the APU's CPU (e.g., a 6-core CPU) operates as a 50 W power load. For the CPU-centric workload, the APU's cooling system can initiate Tj throttling when the CPU power reaches 50 W, resulting in a sustained 50 W level of power support for the entire APU. The systems described herein can reduce or eliminate the discrepancy between power levels supported for different workloads (and different resource utilization profiles) by altering the Tj threshold (e.g., based on whether the workload is CPU-centric or GPU-centric), thereby enabling higher performance.

In addition, many computing devices do not permit users to control system cooling fans (e.g., the fans'speed or maximum speed) through application software or from the operating system environment. While third-party add-ons can exist to limit maximum fan speed, these add-ons can cause security issues due to the associated level of administrative permissions.

The systems described herein can temporarily raise a temperature threshold of a computing system to avoid activating or speeding up cooling fans and to prevent throttling (e.g., power and/or workload throttling) of processors, thereby maintaining quiet system operation and full processing power without sustaining a high temperature for an unsafe period of time. For example, if a user opens a large 3D model file, the systems described herein can temporarily raise a temperature threshold (e.g., a Tj threshold associated with a sustained power limit) so that the computing system can use full processing power to open the file and avoid activating cooling fans. Once the file is open, the computing system can return to its baseline resource usage and not continue producing excess heat. If opening the file takes long enough that the computing system is in danger of sustaining unsafe levels of heat, the systems described herein can lower the temperature threshold back to the baseline level and begin throttling and/or activate fans to reduce the temperature.

In some examples, the systems described herein can define multiple thermal constraints. The transition between each limit can be controlled by time constants. The systems described herein can dynamically adjust these thermal constraints and /r time constraints based on the operating mode to meet ergonomic (e.g., skin temperature, acoustics, etc.) and/or battery life requirements.

Some examples of the systems and techniques described herein exhibit particular advantages relative to alternative power-and temperature-control systems, such as multi-stage power controllers. In some cases, a multi-stage power controller measures the power drawn by a system (e.g., an APU) over different time periods, compares those power measurements to different power limits corresponding to the different time periods, and activates the cooling system (e.g., fan) if the power measurement for a time period exceeds the corresponding power limit. For example, a multi-stage power controller can enforce multiple power limits determined by the amounts of heat the cooling system can dissipate over different time periods, such as (1) a “sustained power limit (SPL)” determined by the amount of heat the cooling system can dissipate indefinitely, (2) a “slow package power tracking (sPPT) limit” determined by the amount of heat the cooling system can dissipate over a relatively long time period (e.g., 5 minutes), and (3) a “fast package power tracking (fPPT) limit” determined by the amount of heat the cooling system can dissipate over a relatively short time period (e.g., 5 seconds). In some cases, when the gaps between these power limits are relatively small, the cooling system can consistently operate the fans at low (and quiet) fan speeds, but the APU's performance can suffer. When the gaps between these power limits are relatively large, the APU's performance can improve, but the fans can frequently toggle between low, quiet speeds and high, noisy speeds.

The systems described herein can have numerous advantages. For example, dynamically adjusting a thermal constraint can lead to fewer instances of throttling when processing dynamic workloads (e.g., workloads characterized by short and/or bursty periods of heavy resource utilization). Reducing the instances of throttling can help mitigate any end-user perception that throttling is a result of poor thermal design. In addition, dynamically adjusting thermal constraints (e.g., increasing the Tj threshold) during cold starts of a processing device (e.g., APU) can allow the device to significantly boost power during the cold start, thereby obtaining better cold-start performance.

Compared to using a multi-stage power controller, using a multi-stage thermal constraint controller (e.g., a controller configured to adapt thermal constraints in accordance with the techniques described herein) can result in quieter fans and less complex fan tables. In some examples, a cooling system uses one or more fan tables to limit the maximum speed at which the fan can operate and the maximum noise produced by the fan. For example, a cooling system can have different fan tables for different operating modes of the processing device (e.g., one fan table for a low-noise operating mode which provides low fan noise and accommodates low levels of device performance, another fan table for a balanced operating mode which permits a moderate level of fan noise and accommodates moderate levels of device performance, and another fan table for a high-performance operating mode which permits high levels of fan noise and accommodates high levels of processor performance). Each fan table can be indexed by Tj, such that the fan speed and noise level are determined by a combination of Tj and the device's operating mode. In contrast, with a multi-stage thermal constraint controller, the cooling system can use a single fan table and can dynamically adjust the thermal constraint (e.g., Tj threshold) to directly limit the maximum fan speed and noise, rather than relying on different operating modes to indirectly limit the maximum fan speed and noise. For example, setting the thermal constraint to a level below the fan's turn-on threshold can guarantee fan-off operation, which can be advantageous when operating in a low-power state such as a standby state.

In some computer systems (e.g., some gaming laptops) having at least one CPU and at least one GPU, a limit on the power drawn by the CPU is switched between two static levels depending on the GPU power state (e.g., depending on whether the GPU is powered on or off). For example, a system can impose a low static limit on CPU power (e.g., 25 W) when the GPU is powered on, while imposing a much higher limit on GPU power (e.g., 80 W). Continuing this example, the system can increase the static limit on CPU power (e.g., to 65 W) when the GPU is powered off. By contrast, with a multi-stage thermal constraint controller, a computing system having at least one CPU and at least one GPU can use a combination of a thermal constraint and a static power limit on CPU power to allow the CPU to opportunistically use more power when the GPU is powered on but drawing relatively little power. For example, when the GPU is powered on, the system can impose a fairly high static limit on CPU power (e.g., 65 W) and a high limit on GPU power (e.g., 80 W), while also imposing a thermal constraint on both the CPU and the GPU (e.g., a Tj threshold of 85° C.). In this configuration, when the GPU is powered on but drawing relatively little power, the CPU can draw much more power, enabling better CPU performance.

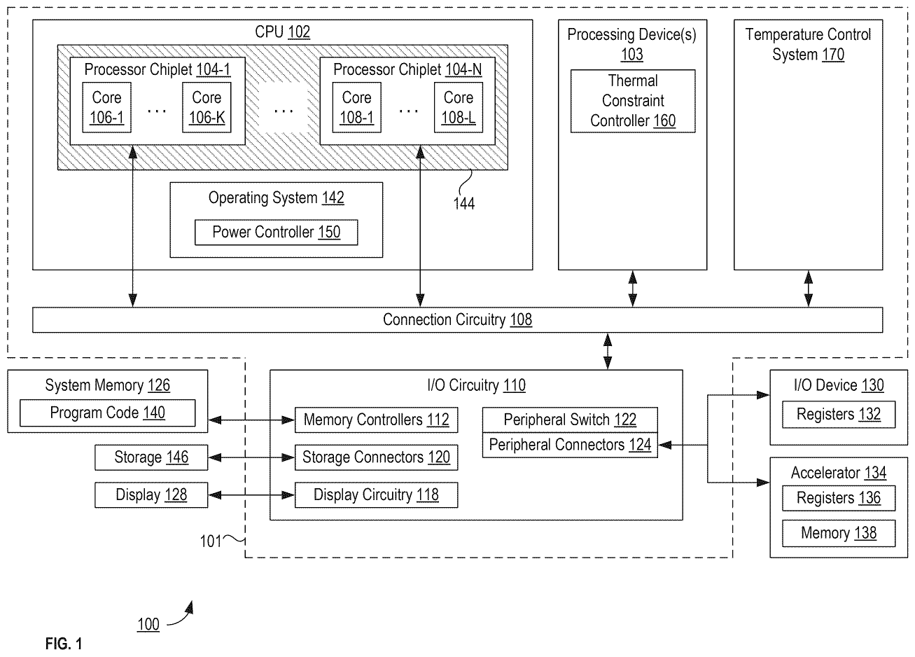

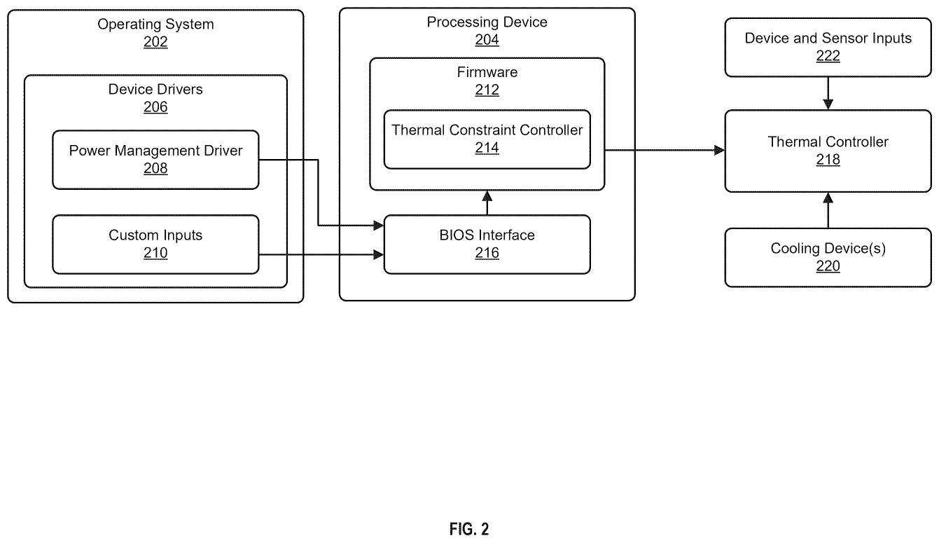

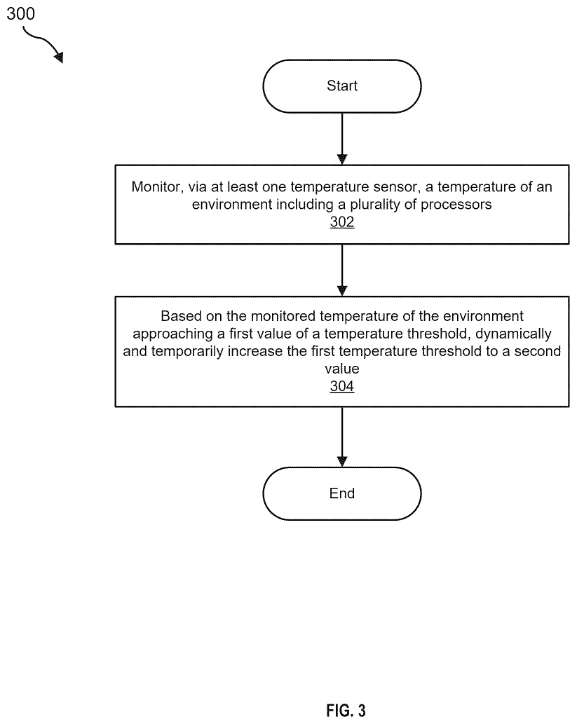

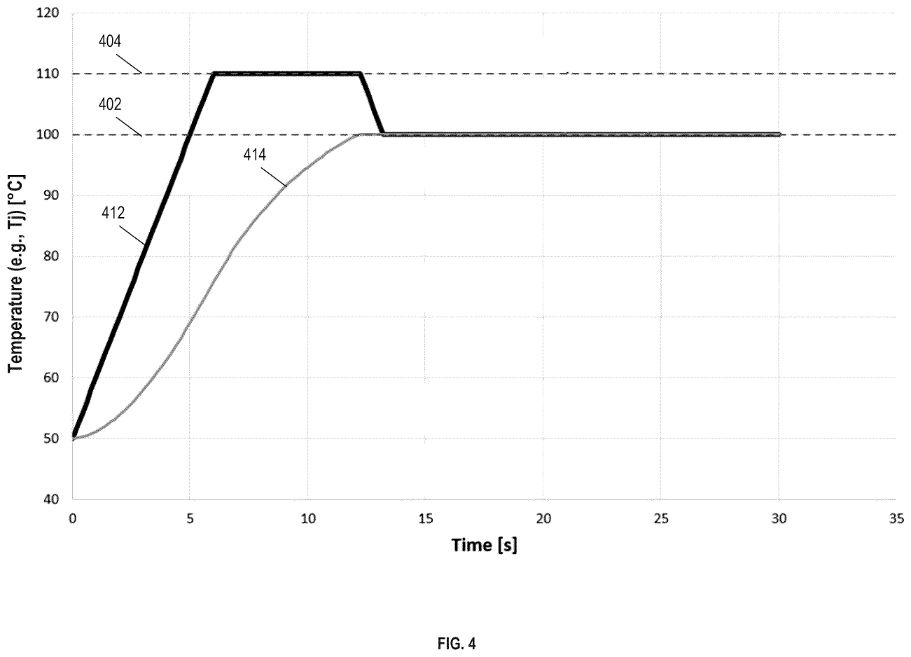

This disclosure provides, with reference to FIGS. 1-2, detailed descriptions of example devices and systems for managing temperature thresholds in computing devices. Detailed descriptions of a corresponding method 300 for dynamically adapting thermal constraints in computing devices is provided in connection with FIG. 3. A graph of exemplary temperature thresholds is provided in connection with FIG. 4.

In some aspects, the techniques described herein relate to a system including: a processor in an environment; at least one temperature sensor configured to monitor a temperature of the environment; a first controller configured to perform an action to reduce the temperature of the environment based on the monitored temperature of the environment reaching a first temperature threshold; and a second controller configured to dynamically adjust the first temperature threshold from a first value to a second value for a limited-duration time period based on the monitored temperature of the environment approaching the first value of the first temperature threshold and to maintain the second value of the first temperature threshold based on the monitored temperature remaining below a second temperature threshold for the limited-duration time period.

In some aspects, the techniques described herein relate to a system, wherein the processor includes an accelerated processing unit including one or more central processing units and one or more graphical processing units.

In some aspects, the techniques described herein relate to a system, wherein: the processor includes a plurality of processors; and the environment includes a computing device including a motherboard to which the plurality of processors are mechanically coupled.

In some aspects, the techniques described herein relate to a system, wherein the at least one temperature sensor includes a plurality of temperature sensors and the monitored temperature includes a maximum temperature measured by the plurality of temperature sensors.

In some aspects, the techniques described herein relate to a system, wherein the monitored temperature includes a junction temperature of a semiconductor junction of a semiconductor device within the processor.

In some aspects, the techniques described herein relate to a system, wherein the at least one temperature sensor is configured to monitor the junction temperature by monitoring an amplitude of a current conducted by the semiconductor junction.

In some aspects, the techniques described herein relate to a system, wherein the second controller is configured to prevent the first controller from performing the action during the limited-duration time period by maintaining the second value of the first temperature threshold for the limited-duration time period.

In some aspects, the techniques described herein relate to a system, wherein the action includes increasing a speed of a fan.

In some aspects, the techniques described herein relate to a system, wherein the action includes throttling the processor.

In some aspects, the techniques described herein relate to a system, wherein the second value of the first temperature threshold is greater than the first value of the first temperature threshold.

In some aspects, the techniques described herein relate to a system, wherein the second controller is configured to decrease the first temperature threshold to a third value based on the monitored temperature of the environment reaching the second value of the temperature threshold, the third value being less than the second value.

In some aspects, the techniques described herein relate to a system, wherein the second controller is configured to dynamically adjust the first temperature threshold by editing a fan control table.

In some aspects, the techniques described herein relate to a device including: a processor; and a second controller configured to perform operations including: receiving temperature information from at least one temperature sensor configured to monitor a temperature of an environment of the processor; and controlling a first controller configured to perform an action to reduce the temperature of the environment based on the monitored temperature of the environment reaching a first temperature threshold, wherein controlling the first controller includes dynamically adjusting the first temperature threshold from a first value to a second value for a limited-duration time period based on the monitored temperature of the environment approaching the first value of the first temperature threshold and to maintain the second value of the first temperature threshold based on the monitored temperature of the environment remaining below a second temperature threshold for the limited-duration time period.

In some aspects, the techniques described herein relate to a method including: monitoring, via at least one temperature sensor, a temperature of an environment including a plurality of processors; and based on the monitored temperature of the environment approaching a first value of a first temperature threshold, dynamically and temporarily increasing the first temperature threshold to a second value, wherein increasing the first temperature threshold prevents a first controller from performing a heat mitigation action based on the monitored temperature reaching the first value of the temperature threshold, wherein temporarily adjusting the first temperature threshold to the second value includes maintaining the second value of the first temperature threshold based on the monitored temperature of the environment remaining below a second temperature threshold.

In some aspects, the techniques described herein relate to a method, wherein performing the heat mitigation action includes increasing a speed of a fan.

In some aspects, the techniques described herein relate to a method, wherein performing the heat mitigation action includes decreasing a power supply voltage provided to the processor.

In some aspects, the techniques described herein relate to a method, wherein performing the heat mitigation action includes decreasing a processing threshold that governs a capacity of the processor.

In some aspects, the techniques described herein relate to a method, wherein the processor includes an accelerated processing unit including one or more central processing units and one or more graphical processing units.

In some aspects, the techniques described herein relate to a method, further including decreasing the first temperature threshold to a third value based on the monitored temperature of the environment reaching the second value of the temperature threshold, the third value being less than the second value.

In some aspects, the techniques described herein relate to a method, wherein maintaining the second value of the first temperature threshold includes: predicting one or more expected temperatures of the environment during a limited-duration time period, the one or more expected temperatures being less than the second temperature threshold.

FIG. 1 illustrates one exemplary implementation of a computer system 100 configured to implement the techniques described herein, although others are possible. It should be appreciated that FIG. 1 is intended neither to be a depiction of necessary components for a computer system 100 to operate in accordance with the principles described herein, nor a comprehensive depiction.

Computer system 100 can be, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. Computer system 100 can comprise at least one central processing unit (CPU) 102, one or more processing devices 103 (e.g., graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), connection circuitry 108, I/O circuitry 110, system memory 126, at least one I/O device 130, at least one accelerator 134, storage 146 (e.g., computer-readable storage media), and/or at least one display 128. In some examples, the CPU 102, processing device(s) 103, connection circuitry 108, and I/O circuitry 110, are coupled to (e.g., mounted on) a printed circuit board (e.g., motherboard) 101.

CPU 102 enables processing of data and execution of instructions. The data and instructions can be stored on system memory 126, storage 146, and/or internal memory (not shown) of the CPU 102. In some examples, the CPU 102 includes one or more processor chiplets 104-1 . . . 104-N, which can be disposed on or over a package substrate 144. In some examples, the processor chiplets can communicate with each other via interconnects routed through or on the package substrate 144 (e.g., through an interposer layer disposed between the package substrate 144 and the processor chiplets). In some examples, each processor chiplet includes one or more cores (106, 108). Different processor chiplets can have the same or different numbers of cores (106, 108). In the example of FIG. 1, processor chiplet 104-1 has K cores 106-1 . . . 106-K, and processor chiplet 104-N has L cores (108-1 . . . 108-L). The cores within an individual processor chiplet (e.g., cores 106-1 . . . 106-K) can be homogeneous or heterogeneous. Likewise, the cores on different processor chiplets (e.g., cores 106-1 and 108-1) can be homogeneous or heterogeneous.

In the example of FIG. 1, the CPU 102 is configured to execute instructions of an operating system 142 and/or instructions (e.g., program code 140) of one or more applications. In some examples, the functionality of the program code can be implemented by one or more processing devices 103, one or more CPUs 102, one or more processor chiplets of a CPU 102, and/or one or more cores of a processor chiplet.

The data and instructions stored on any of the computer-readable storage media (e.g., system memory 126, storage 146, accelerator memory 138, internal or external caches of the CPU 102, etc.) can comprise computer-executable instructions implementing any suitable functionality.

In some examples, connection circuitry 108 communicatively couples CPUs 102 with each other, with processing device(s) 103, and/or with external caches (e.g., level-2 (L2) cache, level-3 (L3) cache, etc.). Additionally or alternatively, the connection circuitry 108 can communicatively couple the CPUs 102 with I/O circuitry 110, which communicatively couples system memory, storage devices, and peripheral devices to each other and (via the connection circuitry 108) to the CPUs 102. The connection circuitry can couple the CPUs 102, external caches, and I/O circuitry 110 using any suitable network topology (e.g., a front-side bus, a back-side bus, etc.), and the coupled components can send and receive messages via the connection circuitry using any suitable communication protocol. In some examples, portions of the connection circuitry 108 can be integrated into the CPU(s) 102 and/or processing device(s) 103.

In some examples, I/O circuitry 110 includes one or more memory controllers 112, one or more storage connectors 120, display circuitry 118, one or more peripheral connectors 124, and a peripheral switch 122. The memory controller(s) 112 can be configured to control the flow of data to and from the system memory 126. The storage connector(s) 120 can be configured to control the flow of data to and from the storage 146. The display circuitry 118 can be configured to send visual data (e.g., user interface data, image data, video data, etc.) to the display 128, which can be configured to display the visual data. In some examples, the display circuitry 118 can also be configured to receive data representing user input from the display 128 (e.g., in cases where the display 128 includes a touchscreen). In some examples, portions of the I/O circuitry 110 can be integrated into a motherboard and/or motherboard chipset (e.g., I/O circuitry 110) of the computer system 100.

Each of the peripheral connectors 124 can be configured to physically connect and communicatively couple the I/O circuitry 110 to a peripheral device. Any suitable type of peripheral device can be connected to a peripheral connector 124 including, without limitation, an I/O device 130 (e.g., an input device, output device, or input/output device), an accelerator 134, etc. Some non-limiting examples of an input device can include a mouse, keyboard, scanner, video game controller, microphone, webcam, etc. Some non-limiting examples of an output device can include a display, printer, speakers, headphones, earbuds, etc. Some non-limiting examples of an input/output device can include a storage device (e.g., disk drive, solid-state drive, universal serial bus (USB) flash drive, memory card, tape drive, etc.), a networking device (e.g., modem, router, gateway, network adapter, access point, etc.), etc. A networking adapter can be any suitable hardware and/or software to enable the computer system 100 to communicate via wires and/or wirelessly with any other suitable computing system over any suitable computing network. The computing network can include wireless access points, switches, routers, gateways, and/or other networking equipment as well as any suitable wired and/or wireless communication medium or media for exchanging data between two or more computers, including the Internet. Optionally, an I/O device can include one or more registers 132. In some examples, the I/O circuitry 110 can control the operation of an I/O device 130 by writing suitable data to one or more of the I/O device's registers, and/or can monitor the status of an I/O device 130 by reading the contents of one or more of the I/O device's registers.

Some non-limiting examples of an accelerator 134 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc. In some examples, an accelerator 134 includes one or more registers 136 and memory 138. In some examples, the I/O circuitry 110 can control the operation of an accelerator 134 by writing suitable data to one or more of the accelerator's registers, and/or can monitor the status of an accelerator 134 by reading the contents of one or more of the accelerator's registers.

The peripheral switch 122 can be configured to switch packets sent to or from the peripheral devices. Any suitable type of peripheral connector(s) 124 and peripheral switch 122 can be used including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc.

As described above computer system 100 can have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

In some examples, computer system 100 further includes a power controller 150, a thermal constraint controller 160, and a temperature control system 170. In some examples, the power controller 150 can dynamically adapt the system's operating mode(s) (e.g., based on user input, system workload, various power limits, etc.). In some examples, dynamically adapting the system's operating mode(s) can include dynamically setting or changing the operating mode of the processing device(s) 103. In some examples, the power controller 150 is implemented as a device driver within the operating system 142.

In some examples, the thermal constraint controller 160 can dynamically adapt thermal constraints on the operation of the system 100 or components thereof (e.g., processing device(s) 103). In some examples, dynamically adapting thermal constraints on the operation of the processing device(s) 103 can include setting or changing a dynamic Tj threshold applicable to the processing device(s) 103. In some examples, the thermal constraint controller is a multi-stage thermal constraint controller. In some examples, the thermal constraint controller 160 includes one or more sensors operable to measure the temperature at one or more locations within the system 100, or receives temperature measurements from such sensors. The temperature measurements can include, for example, measurements of the junction temperature (Tj) of one or more junctions of the system 100 (e.g., one or more junctions of the processing device(s) 103). In some examples, the thermal constraint controller 160 dynamically adapts the thermal constraints based on temperature data (e.g., data indicative of, derived from, or based at least in part on the temperature measurements). In some examples, the thermal constraint controller 160 compares the temperature data to one or more thermal constraints (e.g., Tj thresholds), and sends a message to the temperature control system 170 if the temperature data indicates that a thermal constraint has been violated.

In some examples, the temperature control system 170 includes one or more temperature regulators (e.g., fans, liquid cooling systems, etc.), and controls the activity of the temperature regulators (e.g., fan speed, circulation of liquid coolant, etc.). In some examples, the temperature control system 170 controls the activity of the temperature regulator(s) based, at least in part, on messages received from the thermal constraint controller 160.

FIG. 2 illustrates an exemplary system for dynamically adapting thermal constraints in computing devices. As illustrated in FIG. 2, a computing system can include an operating system 202 with device drivers 206, such as a power management driver 208 and/or custom inputs 210 (e.g., battery settings, user modes, etc.). In some examples, power management driver 208 can dynamically adapt the system's operating mode based on a user's behavior. In some examples, the power management driver 208 implements the power controller 150. A computing system can also include a processing device 204, such as an APU, that can include a BIOS interface 216 that receives information from power management driver 208 and/or custom inputs 210 and transmits information to firmware 212. In some examples, operating system 202 can be executing on processing device 204 while in other examples, operating system 202 can be executing on a different processing device.

In one example, BIOS interface 216 can include a dynamic power and thermal control interface that interacts with and influences system management unit firmware, such as firmware 212. Firmware 212 can be a system management unit responsible for controlling various power, thermal, and/or performance aspects of processing device 204. In some examples, firmware 212 includes or implements a thermal constraint controller 214 (e.g., thermal constraint controller 160) and can interface with a temperature control system (e.g., temperature control system 170), which can include a thermal controller 218 and one or more cooling device(s) 220. In some examples, the thermal controller 218 (e.g., a system embedded microcontroller) receives input not only from the thermal constraint controller 214, but also from cooling device(s) 220 (e.g., one or more fans, coolant in liquid cooling systems, etc.) and/or device and sensor inputs 222 (e.g., other systems devices and/or sensors).

In some examples, thermal controller 218 can be configured to perform an action to reduce the temperature of the environment based on the monitored temperature of the environment (e.g., as measured at a thermal junction of processing device 204) reaching a first temperature threshold. In one example, thermal constraint controller 214 can be configured to configured to dynamically adjust the first temperature threshold from a first value to a second value for a limited-duration time period based on the monitored temperature of the environment approaching the first value of the first temperature threshold and to maintain the second value of the first temperature threshold based on the monitored temperature remaining below a second temperature threshold for the limited-duration time period. Additionally, firmware 212 can be configured to prevent thermal controller 218 from performing an action (e.g., increasing fan speed of cooling device(s) 220, throttling processing device 204, etc.) during the limited-duration time period by maintaining the second value of the first temperature threshold for the limited-duration time period. In some examples, thermal constraint controller 214 can be configured to decrease the first temperature threshold to a third value based on the monitored temperature of the environment reaching the second value of the temperature threshold, the third value being less than the second value. In some examples, thermal constraint controller 214 can dynamically adjust the first temperature threshold by editing a fan control table.

As illustrated in FIG. 3, at step 302, firmware 212 can monitor, via at least one temperature sensor, the temperature of an environment including a plurality of processors (e.g., processing device 204). In one example, the environment can include a motherboard to which the processors are mechanically coupled. In some examples, the environment can be configured such that the temperature of any processor affects the temperature of the environment and thus the temperature of the other processors within the environment. In one example, firmware 212 can monitor the temperature of the environment via a group of sensors (e.g., arranged at various different points within the environment) and can use the maximum temperature measured by any sensor as the temperature of the environment. In some examples, one or more temperature sensors can measure one or more junction temperatures of semiconductor junctions within processing device 204, in some examples by monitoring the amplitude of current conducted by the semiconductor junction.

At step 304, thermal constraint controller 214 can, based on the monitored temperature of the environment approaching a first value of a temperature threshold, dynamically and temporarily increase the first temperature threshold to a second value. For example, as illustrated in FIG. 4, a thermal constraint controller 214 can maintain a first value 402 (e.g., 100° C.) of a temperature (e.g., Tj) threshold. Based on any suitable input or stimulus, the thermal constraint controller 214 can dynamically and temporarily change the temperature threshold to a second value 404 (e.g., 110° C.). For example, the thermal constraint controller 214 can change the temperature threshold to the second value based on a first temperature 412 (e.g., a current or instantaneous Tj) of a processing device approaching the first value 402 of the temperature threshold. In some examples, the thermal constraint controller 214 can maintain the second value 404 of the temperature threshold until a second temperature 414 (e.g., a moving average Tj) of the processing device approaches or reaches the first value 402 of the temperature threshold. Based on the second temperature 414 approaching or reaching the first value 402 of the temperature threshold, the thermal constraint controller can dynamically change the temperature threshold back to the first value 402. In some examples, the second temperature 414 is a moving average of the junction temperature Tj of the processing device over a lagging time period of any suitable duration (e.g., 3 seconds, 5 seconds, 10 seconds, etc.). In some examples, the moving average is weighted. In some examples, the moving average is exponentially weighted (e.g., by an exponential alpha filter with any suitable time constant, for example, 3 seconds, 5 seconds, 10 seconds, etc.).

Other protocols for dynamically and temporarily adjusting the value of the temperature threshold can be used. For example, the first value of a temperature threshold can be 100° C. In response to a temperature (e.g., Tj) of a processing device 204 approaching the first value of the temperature threshold, thermal constraint controller 214 can increase the temperature threshold to a second value (e.g., 110° C.) for a limited duration (e.g., five seconds, ten seconds, thirty seconds, one minute, two minutes, five minutes, etc.). At the end of this duration, thermal constraint controller 214 can return the temperature threshold to the first value. In some examples, thermal constraint controller 214 can set the limited duration based in part on calculating that the temperature is predicted to not exceed a safe operating temperature during the limited duration.

In some examples, thermal constraint controller 214 can store multiple different temperature thresholds. For example, thermal constraint controller 214 can store a baseline temperature threshold that can be maintained indefinitely without causing heat damage to the system or the user, a medium-term temperature threshold that can be maintained for several minutes without causing heat damage, and a short-term temperature threshold that can be maintained for less than a minute without causing heat damage. In other examples, thermal constraint controller 214 can store four or more different temperature thresholds.

In some examples, thermal constraint controller 214 can alter one or more stored temperature thresholds. For example, if the computing system is in use for a long time and the thermal paste dries out, thermal constraint controller 214 can adjust one or more temperature thresholds downward to account for the system's reduced ability to dissipate heat.

In one example, firmware 212 can be integrated into a platform management framework driver as part of ASM. In some examples, ASM can dynamically adapt the system's operating mode based on user's behavior. In some examples, ASM can have the ability to directly control maximum fan noise for each state without sending an advanced configuration and power interface message to the thermal controller 218.

In one example, firmware 212 can edit a fan control table to adjust and/or implement temperature thresholds. For example, firmware 212 can combine a silent mode, balanced mode, and performance mode into a single fan table by setting temperature limits of 64° C., 74° C., and 100° C., respectively. In some examples, setting the temperature threshold to below the fan turn-on threshold can guarantee fan-off operation while in low power states such as modern standby

An example has been described in which a cooling system has one or more fan tables and a thermal constraint controller can dynamically adjust a thermal constraint (e.g., Tj threshold) to directly limit the maximum fan speed and noise, rather than relying on different operating modes to indirectly limit the maximum fan speed and noise. In such examples, the power management driver 208 can implement system performance modes without depending on the thermal controller 218. For example, the fan tables can be stored in memory accessible to the operating system 202 (rather being stored in the thermal controller 218), and the power management driver 208 can place the processing device 204 in the desired performance mode by controlling the thermal constraint controller to adjust the thermal constraint (e.g., Tj threshold) to a value corresponding to the desired power level and/or noise level, as indicated by the fan table(s). In some examples, this approach is beneficial because (1) auto state management (ASM) does not depend on the thermal controller 218, (2) the number and size of the fan table(s) are not limited by the amount of space available in the memory of the thermal controller 218, and (3) the control logic of the thermal constraint controller 214 can be implemented in the power management driver 208 rather than in firmware 212 of the processing device 204.

In some examples, the systems described herein can enable more efficient utilization of CPUs on APUs by providing more power to a CPU when the CPU temperature is below the temperature threshold even when the GPU is being utilized.

Techniques operating according to the principles described herein can be implemented in any suitable manner. While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts of processes that regulate the voltage of a signal. The processing and decision blocks of the flowcharts above represent steps and acts that can be included in algorithms that carry out these processes. Algorithms derived from these processes (or steps thereof) can be implemented as software integrated with and directing the operation of one or more single-or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and examples of the principles described herein.

Accordingly, in some examples, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative examples, be adapted to interact with other, unrelated functional facilities and/or processes, to implement a software program application. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that examples are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some examples, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory 126, accelerator memory 138, and/or storage 146 of the computer system 100 of FIG. 1 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described above comprise acts of storing information (e.g., data and/or instructions) in certain ways for use by these techniques. In some implementations of these techniques-such as implementations where the techniques are implemented as computer-executable instructions-the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Examples have been described where the techniques are implemented in circuitry and/or computer-executable instructions. It should be appreciated that some examples can be in the form of a method, of which at least one example has been provided. The acts performed as part of the method can be ordered in any suitable way. Accordingly, examples can be constructed in which acts are performed in an order different than illustrated, which can include performing some acts simultaneously, even though shown as sequential acts in illustrative examples.

Various aspects of the examples described above can be used alone, in combination, or in a variety of arrangements not specifically discussed in the examples described in the foregoing and is therefore not limited in its application to the details and arrangement of components set forth in the foregoing description or illustrated in the drawings. For example, aspects described in one example can be combined in any manner with aspects described in other examples.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any example, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one example, to A only (optionally including elements other than B); in another example, to B only (optionally including elements other than A); in yet another example, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within ±20%, ±10%, or ±5% of the second numeric value.

Having thus described several aspects of at least one example, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A system comprising:
a processor in an environment;
at least one temperature sensor configured to monitor a temperature of the environment;
a first controller configured to perform an action to reduce the temperature of the environment based on the monitored temperature of the environment reaching a first temperature threshold; and
a second controller configured to dynamically adjust the first temperature threshold from a first value to a second value for a limited-duration time period based on the monitored temperature of the environment approaching the first value of the first temperature threshold and to maintain the second value of the first temperature threshold based on the monitored temperature remaining below a second temperature threshold for the limited-duration time period.

2. The system of claim 1, wherein the processor comprises an accelerated processing unit comprising one or more central processing units and one or more graphical processing units.

3. The system of claim 1, wherein:
the processor comprises a plurality of processors; and
the environment comprises a computing device including a motherboard to which the plurality of processors are mechanically coupled.

4. The system of claim 1, wherein the at least one temperature sensor comprises a plurality of temperature sensors and the monitored temperature comprises a maximum temperature measured by the plurality of temperature sensors.

5. The system of claim 1, wherein the monitored temperature comprises a junction temperature of a semiconductor junction of a semiconductor device within the processor.

6. The system of claim 5, wherein the at least one temperature sensor is configured to monitor the junction temperature by monitoring an amplitude of a current conducted by the semiconductor junction.

7. The system of claim 1, wherein the second controller is configured to prevent the first controller from performing the action during the limited-duration time period by maintaining the second value of the first temperature threshold for the limited-duration time period.

8. The system of claim 1, wherein the action comprises increasing a speed of a fan.

9. The system of claim 1, wherein the action comprises throttling the processor.

10. The system of claim 1, wherein the second value of the first temperature threshold is greater than the first value of the first temperature threshold.

11. The system of claim 1, wherein the second controller is configured to decrease the first temperature threshold to a third value based on the monitored temperature of the environment reaching the second value of the temperature threshold, the third value being less than the second value.

12. The system of claim 1, wherein the second controller is configured to dynamically adjust the first temperature threshold by editing a fan control table.

13. A device comprising:
a processor; and
a second controller configured to perform operations including:
receiving temperature information from at least one temperature sensor configured to monitor a temperature of an environment of the processor; and
controlling a first controller configured to perform an action to reduce the temperature of the environment based on the monitored temperature of the environment reaching a first temperature threshold,
wherein controlling the first controller comprises dynamically adjusting the first temperature threshold from a first value to a second value for a limited-duration time period based on the monitored temperature of the environment approaching the first value of the first temperature threshold and to maintain the second value of the first temperature threshold based on the monitored temperature of the environment remaining below a second temperature threshold for the limited-duration time period.

14. A method comprising:
monitoring, via at least one temperature sensor, a temperature of an environment including a plurality of processors; and
based on the monitored temperature of the environment approaching a first value of a first temperature threshold, dynamically and temporarily increasing the first temperature threshold to a second value,
wherein increasing the first temperature threshold prevents a first controller from performing a heat mitigation action based on the monitored temperature reaching the first value of the temperature threshold,
wherein temporarily adjusting the first temperature threshold to the second value includes maintaining the second value of the first temperature threshold based on the monitored temperature of the environment remaining below a second temperature threshold.

15. The method of claim 14, wherein performing the heat mitigation action comprises increasing a speed of a fan.

16. The method of claim 14, wherein performing the heat mitigation action comprises decreasing a power supply voltage provided to the processor.

17. The method of claim 14, wherein performing the heat mitigation action comprises decreasing a processing threshold that governs a capacity of the processor.

18. The method of claim 14, wherein the processor comprises an accelerated processing unit comprising one or more central processing units and one or more graphical processing units.

19. The method of claim 14, further comprising decreasing the first temperature threshold to a third value based on the monitored temperature of the environment reaching the second value of the temperature threshold, the third value being less than the second value.

20. The method of claim 14, wherein maintaining the second value of the first temperature threshold comprises:
predicting one or more expected temperatures of the environment during a limited-duration time period, the one or more expected temperatures being less than the second temperature threshold.
